(19) United States
(12) Patent Application Publication
(10) Pub. No.: US 2016/0328312 A1
(43) Pub. Date: Nov. 10, 2016

(54) ENHANCED STABILITY OF AUTOMATION EXECUTION VIA USE OF STATE MACHINE PATTERN AND EXPECTED CONDITIONS WHEN EXECUTING AN ACTION ON AN APPLICATION ELEMENT

(71) Applicant: Halogen Software Inc., Kanata (CA)

(72) Inventors: Chris Loder, Carleton Place (CA); Mathieu Jobin, Ottawa (CA)

(21) Appl. No.: 14/983,727

(22) Filed: Dec. 30, 2015

Related U.S. Application Data
(60) Provisional application No. 62/156,442, filed on May 4, 2015.

(51) Int. Cl. G06F 11/36; G06F 9/44

(52) U.S. Cl. CPC G06F 11/3664; G06F 8/38

(57) ABSTRACT

An automation testing framework is provided for testing user interface elements in an application. Actions may be executed on elements of the application using a state machine in order to eliminate a need to insert wait periods into the test tool. An adaptive delay is applied to execution of the user interface element when execution cannot be validated prior to re-execution of the user interface element. The adaptive delay removes testing instability and accelerating testing of the application.

### CROSS-REFERENCE

This application claims priority from U.S. Provisional Application No. 62/156,442 filed May 4, 2015 the entirety of which is hereby incorporated by reference for all purposes.

### TECHNICAL FIELD

The current disclosure relates to application testing, and in particular to verifying operation of elements in an application for verification of application operation.

### BACKGROUND

Testing computer programs is an important part of the development process to ensure the program and user interface performs as expected. Various types of testing may be used throughout development. Unit testing may be used to verify the current functioning of individual components such as functions or classes. Integration testing may test a number of components or units that function together to verify that the components operate together correctly. Further, black box testing may be used at the application level to verify that the application functions as it is supposed to. The testing process is typically automated to allow large number of tests to be performed in a short period of time.

When testing applications, an automation framework may be used to allow interactions with elements to be automated. For example, an automation framework may be used to allow a testing program to simulate a user clicking on a button, or typing in a text box. The results of the automated interaction may be compared to an expected outcome to verify the correct functioning of the application.

When testing an application such as for example web applications, the test application may attempt to interact with an element on the web page that is not yet available, or services associated with the element are not available. In order to prevent errors resulting from such attempts, the test application may insert time delays in order to ensure the test waits a sufficient amount of time to load all of the required elements. The use of such wait times may slow down the testing process unnecessarily. Further, if the application changes, a longer wait time may be required and the test application may be broken.

An additional, alternative and/or improved technique for use in automating testing of applications is desirable.

### BRIEF DESCRIPTION OF DRAWINGS

Further features and advantages of the present disclosure will become apparent from the following detailed description, taken in combination with the appended drawings, in which:

FIG. 1 depicts components of a computing device for automated testing of applications;

FIG. 2 depicts a testing process in which the state machine executor may be used;

FIG. 3 depicts processing of actions in an action execution state machine; and

FIG. 4 depicts a method of enhanced stability of automation execution on application elements.

### DETAILED DESCRIPTION

In accordance with an aspect of the present disclosure there is provided a computing device for automated testing of an application, the computing device comprising: a processing unit for executing instructions; a memory unit for storing instructions, which when executed by the processing unit configure the computing device to provide: an automation framework providing an application programming interface (API) for controlling interactions with one or more user interface elements of the application; and an execution state machine for executing action on user interface elements through the automation framework, the execution state machine comprising a plurality of states associated with the user interface element defined in the application, wherein one of the states is associated to the user interface element during execution of a test step in the automation framework wherein when a failure of an action on the user interface element occurs an adaptive delay is applied before attempting to re-execute the action until the state of the user interface element is validated or the adaptive delay is exceeded.

In accordance with an aspect of the present disclosure the state machine defines the plurality of states as: an UNKNOWN state when the user interface element is being loaded; a FOUND state when the user interface element is successfully loaded; a VALIDATING state when the result of an attempted action is being validated; and an UNSTABLE state when the validation of the action fails in the VALIDATING state.

In accordance with an aspect of the present disclosure when transitioning from the VALIDATING state to the UNSTABLE state upon failing the attempted action the adaptive delay is applied.

In accordance with an aspect of the present disclosure the adaptive delay increases the delay upon each subsequent delay.

In accordance with an aspect of the present disclosure when validating the attempted action in the VALIDATING state, one or more conditions are checked against expected conditions resulting from execution of the action.

In accordance with an aspect of the present disclosure the expected conditions are selected from a plurality of predefined conditions.

In accordance with an aspect of the present disclosure the plurality of predefined conditions comprise one of: AlertVisible; ElementAttributeContains; ElementAttributeNotContains; ElementChanged; ElementCheckboxValueEquals; ElementClickable; ElementEnabled;

ElementInvisible; ElementIsSelected; ElementTextContains; ElementTextEquals; ElementValueEquals; ElementVisible; WindowClosed; and WindowOpened.

In accordance with an aspect of the present disclosure the application is a web application and the user interface element are is a web-based user interface.

In accordance with an aspect of the present disclosure there the state machine has a maximum timeout wherein the testing is terminated when the maximum timeout is reached.

In accordance with another aspect of the present disclosure there is provided a method of automated testing of an application executed on a computing device, the method comprising: executing an action on an interface element in the application identified in a test step; setting a state associated with an element when the interface element is being loaded; loading the interface element in the application associated with the action; attempting the action defined for the interface element; changing the state associated with the interface element during execution; verify conditions of the element against expected conditions; applying an adaptive delay between subsequent execution of the actions when the expected conditions for the interface element are not met; iteratively re-executing the action on the interface element where the adaptive delay is applied until the action is verified or the adaptive delay expires.

In accordance with another aspect of the present disclosure changing the state comprises: setting a state associated with an element defined for the action to UNKNOWN when a web element is being loaded; setting the state associated with the element to FOUND when the web element is successfully loaded; setting the state to VALIDATING when the result of an attempted action is being validated; and setting the state to UNSTABLE when the validation of the action fails in the VALIDATING state.

In accordance with another aspect of the present disclosure when transitioning from the VALIDATING state to the UNSTABLE state upon failing the attempted action the adaptive delay is applied.

In accordance with another aspect of the present disclosure there is provided the adaptive delay increases the delay upon each subsequent delay.

In accordance with another aspect of the present disclosure there is provided validating the attempted action in the VALIDATING state, one or more conditions are checked against expected conditions resulting from execution of the action.

In accordance with another aspect of the present disclosure there is provided the expected conditions are selected from a plurality of predefined conditions.

In accordance with another aspect of the present disclosure there is provided the application is a web application and the user interface element are web-based user interface elements defined in a browser.

In accordance with another aspect of the present disclosure there is provided the state machine has a maximum timeout wherein the testing is terminated when the maximum timeout is reached.

In accordance with another aspect of the present disclosure there is provided the adaptive delay is increased by 1 second on each subsequent attempt until a maximum timeout is reached.

In accordance with yet another aspect of the present disclosure there is provided a non-transitory computer readable memory containing instructions for automated testing of an application executed on a computing device, the instructions which when executed by a processor performing: executing an action on an interface element in the application identified in a test step; setting a state associated with an element when the interface element is being loaded; loading the interface element in the application associated with the action; attempting the action defined for the interface element; changing the state associated with the interface element during execution; verify conditions of the element against expected conditions; applying an adaptive delay between subsequent execution of the actions when the expected conditions for the interface element are not met; iteratively re-executing the action on the interface element where the adaptive delay is applied until the action is verified or the adaptive delay expires.

Current automation frameworks rely on the testing tool involved to supply proper waits and control for action executing with user interface elements in a web application or user interface elements in a compiled application program. This has been problematic in that it requires the testing tool to dictate when it thinks the application is ready to proceed. The testing tool may simply rely on a browser or application ready state which is may not be sufficient to ensure that all required elements have been loaded. This means that typically a sleep or wait has to be inserted into the code to allow enough time for actions to complete. As described further below, an action executor may be used in executing actions on elements and validating when an element action has been successfully completed. When executing an action through the action executor, it is not necessary to specify wait times to ensure that the desired elements are available prior to executing the action.

The action executor also allows knowing exactly where a failure has taken place. In older frameworks, since no condition checks or inline validation took place, it wasn't possible to know if an action had failed until later in the test case when it was attempted to make use of the results of the previous action. An example would be trying to use a process that failed to save properly. Previously, time would be spent trying to determine why the process wouldn't allow input; however the problem results from an unsuccessful action that occurred three steps ago on the save. This stability pinpoints the exact location of the failure.

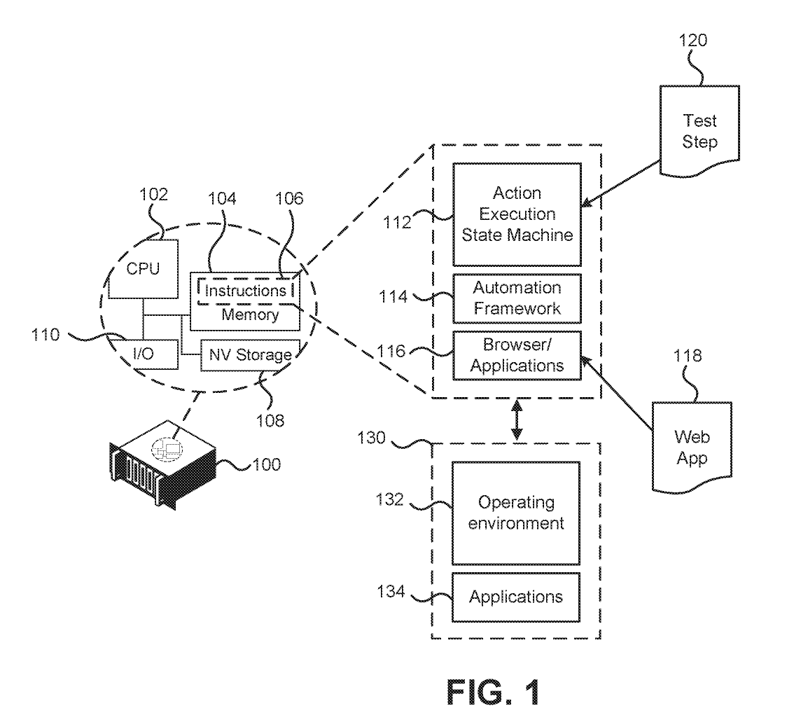

FIG. 1 depicts components of a computing device for automated testing of applications. The computing system 100 comprises a processing unit 102 that can execute instructions to configure the computing system to provide various functionality. The computing system 100 further comprises a memory unit 104 for storing instructions 106. The computing system 100 may further comprises non-volatile storage 108 for storing instructions and or data as well as an input/output (I/O) interface 110 for connecting one or more additional peripherals to the computing system 100.

The instructions, when executed by the processing unit 102, provide a browser 116 that can display a web application 118. An automation framework 114 may provide an interface for interacting with an application executed on the computing device, an application executed and displayed in the browser or an application executed to another connected computing device 130. The instructions may further include an action execution state machine 112 that executes actions of a test step 120 using the automation framework 114. The connected device 130 may be a mobile device, having at least a processor and memory for executing instruction for providing an operating environment 132 to execute applications 134 or browsers thereon. The connected device 130 can be connected to the computing system 100 through a network where the automation framework 114 interacts with the application 134 to execute test steps 120 using action execution state machine 112.

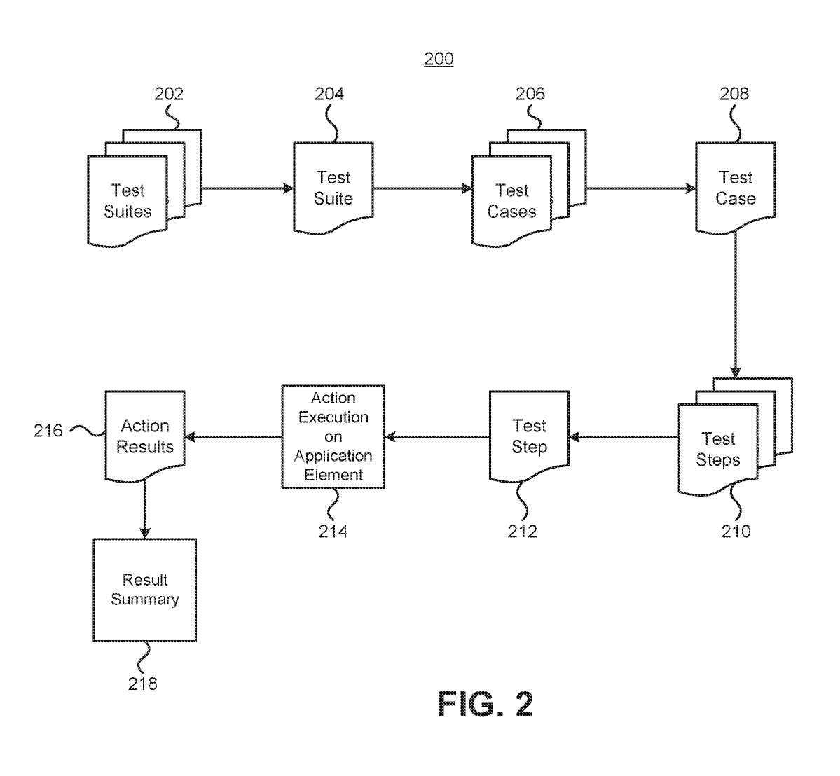

FIG. 2 depicts a testing process in which the state machine executor may be used. The process 200 has a number of test suites 202 that can be used to test an application. Each of the test suites, such as test suite 204, comprise one or more test cases 206. Each of the test cases 206, such as test case 208, may have a number of test steps 210 that should be executed. Each of the test steps, such as test step 212, are executed by an action executor 214 that uses a state machine to execute the test steps on an application element. The execution results in particular action results 216 that can be summarized 218.

As an example, a test suite may be used for testing user interactions with application elements for example interface elements on web site. One of the test cases may be, for example, testing a user registration process and the test steps may include entering a user name, a user password and clicking a registration button. The action execution may attempt executing each step until an expected condition is met, or until a set amount of time has passed.

The process 200 may be performed by a test tool, such as an automation engine that may read a configuration file or files and sets of the testing environment. A number of tests cases may be collected from one or more test suites to be run. Each of the test cases, which each may comprise one or more test steps, may be executed individually. Each of the test steps may be an action and/or validation on a user interface element of the application being tested. The actions of the tests are executed by the state machine of the action executor and once the case is complete, the next test case may be executed. Results may be summarized once the tests are completed.

The rest results can then be used to validate interaction with the application and identify and user interface elements that were not validated.

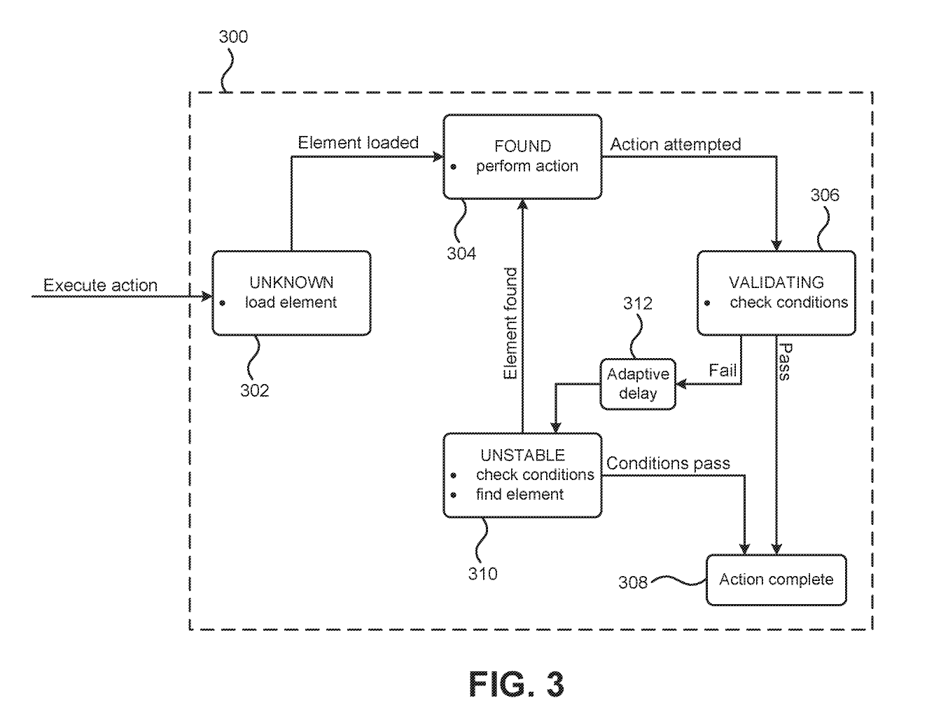

FIG. 3 depicts processing of actions in an action execution state machine. The action execution state machine 300 comprises a number of states that are transitioned between defined for elements in a user interface of an application. When an action is executed, the element is placed into an UNKNOWN state 302 and the element loaded. Once loaded, the state transitions to a

FOUND state 304 and the action is attempted to be executed and the state transitioned to a VALIDATING state 306. In the VALIDATING state 306, conditions of the element are checked against expected conditions. If the resultant conditions match the expected conditions, the action is complete 308. If the condition checks do not pass, an adaptive delay 312 is applied and the state transitioned to an UNSTABLE state. In the UNSTABLE state, the condition is checked again and if the condition check passes, the action is complete. If the condition check fails, the element is attempted to be located, and the state transitions to the FOUND state.

The goal of a test step is to complete an action on an element. The process comprises:
Setting the elements state to UNKNOWN and then loading the element. The load may comprise more than just a single find, it will be retried until the max time out to find the element has been passed. Once the find is complete, the element is initialized. Initializing is used to set or store any precondition information. In the example of a text box, the initialization may collect the existing text before acting upon the text box so that when the action is evaluated post action, the original text is available for use in validation.
Once loaded, the elements state is set to FOUND and the intended action (i.e. click, set text, select list item, etc. . . . ) on the element is performed, or attempted to be performed.
   After the action is attempted, the state of the element is changed to VALIDATING and the expected conditions for the element are checked.
   If the expected conditions are met (alert visible, text changed, element selected, etc. . . . ) then the action is considered complete and the next element and action are processed.
   If the expected conditions are not met an adaptive delay is applied and the the state of the element is set to UNSTABLE. In the UNSTABLE state the conditions are checked again.
      If the conditions are met, the action is considered complete and the next element and action are processed.
      If the expected conditions are not met, the element is found again. The element remains in the UNSTABLE state until the element is found again, or the max timeout has been reached.
      Once the element is found, the state is set to FOUND and the process repeats itself.
If at any time during the above, an exception is thrown (StaleElementReferenceException, NoSuchWindowException, etc. . . . ) the state is set to VALIDATING and the processing cycle continues.
This whole process is in a timed loop. The timeout max time is set in the framework. The loop will continue to execute until the max timeout is reached, at which time if the action has not been deemed completed, the loop breaks and an exception is thrown.
The framework then proceeds to clean-up and move on to the next test case.

As described above, an adaptive delay may be applied when transitioning from the VALIDATING state to the UNSTABLE state. The adaptive delay may prevent a runaway action. Without an adaptive delay, certain actions may simply be retried as fast as the code could cycle through the loop. This may cause the application under test to be overloaded with requests and result in it causing a crash. The adaptive delay slows the attempts down.
In a first pass through the delay it will wait 1 second before moving on to the UNSTABLE state.
Subsequent passes increase the delay by 1 second. So the second pass through the Adaptive delay would take a 2 second wait, third 3 seconds and so on.
This will continue until the max timeout is met.
Every time a new action is executed on a new element, the Adaptive Delay is reset and starts over.

The list of expected conditions may be selected from a number of predefined conditions. The expected conditions may include, but are not limited to, for example:
AlertVisible—used when an alert is expected to pop up.
ElementAttributeContains—used when a given attribute of an element is expected to contain certain text.
ElementAttributeNotContains—used when a given attribute of a Web Element is expected to not contain certain text.
ElementChanged—used when an element is expected to change. This is mostly used for text boxes. The text is compared with what it was before the action took place.
ElementCheckboxValueEquals—used when a given check box Web Element is expected to be either checked or unchecked.
ElementClickable—used when an element is expected to be clickable.
ElementEnabled—used when an element is expected to be on screen and enabled.
Elementlnvisible—used when an element is expected to no longer be visible on the screen.
ElementIsSelected—used when that the given an element is expected to be selected.
ElementTextContains—used when the text value of the given Web Element is expected to contain a particular string value.
ElementTextEquals—used when the text value of the given element is expected to match a particular string value.
ElementValueEquals—used when the value attribute of the given attribute is expected to equal a given string value.
ElementVisible—used when the given element is expected to be visible on the screen.
WindowClosed—used when the action performed on the given element is expected to cause a window to close.
WindowOpened—used when the action performed on the given element is expected to cause a window to open.

Additional or alternative expected conditions may be used and the above are only illustrative.

Validation objects may also be provided which enable traversing through the action executor code. The validation objects follow the same steps as an action such as a click or type, but instead of performing an action, they perform a validation. The validation objects provides stability of waiting and retrying validations.

Various implementations of the action executor are possible. The following code provides one illustrative embodiment of an action executor.

public static void executeAction(UIAction action, int max_wait) {

ActionState currentState = ActionState.UNKNOWN;

```
  // The delay between action retries is 1 second.
  AdaptiveDelay actionDelayer = new AdaptiveDelay(1000);
  actionDelayer.delay( ); // We want the first delay to be non-
```

zero.

long startTime= System.currentTimeMillis( );
long endTime = startTime + (max_wait);
long individualClickStart = −1;
long timingDelta = −1;
boolean passed = false;
Logger.log(action, LogLevel.INFO);
boolean browserNotReached = false;
boolean seleniumTimeout = false;
// Try for max_wait, or until a condition is satisfied.
while (System.currentTimeMillis( ) < endTime && !passed){

try {

switch (currentState) {

case UNKNOWN:

action.loadElem( );
currentState = ActionState.ELEM_FOUND;
break;

// This is the ACTION Block.

case ELEM_FOUND:

currentState =
ActionState.VALIDATING;
individualClickStart =

System.currentTimeMillis( );

action.perform( );

break;

// The UNSTABLE STATE should only be accessed

after a VALIDATING step.

// VALIDATING −> UNSTABLE is the

only flow that allows for proper retries.

case UNSTABLE:

// Verify if the conditions are satisfied.
if (action.checkConditions( )){

passed = true;
timingDelta = (System.currentTimeMillis(

) − individualClickStart);

break;

}
if (action.findElement( )){

// Retry the action.
Logger.log(“Found original element,

retrying”, LogLevel.INFO);

currentState = ActionState.ELEM_FOUND;

} else {

// Check the conditions again.
Logger.log(“Original element not found”,

LogLevel.INFO);

currentState = ActionState.VALIDATING;

}
break;

// For any type of conditino checking, we

need the actionexecutor to pass by VALIDATING.

case VALIDATING:

if (action.checkConditions( )){

passed = true;
timingDelta = (System.currentTimeMillis(

) − individualClickStart);

} else {

actionDelayer.delay( );

currentState = ActionState.UNSTABLE;

}
break;

default:

break;

}

//Sporadicaly throws these upon a click and a 60s timeout.
//Reset the timer, and mark it as a flag, as to not get stuck in

an endless loop.

} catch (UnreachableBrowserException e) {

currentState = ActionState.VALIDATING;

Logger.log(“Browser not reached, retrying”,
LogLevel.ERROR);
if (!browserNotReached) {

startTime= System.currentTimeMillis( );
endTime = startTime + (max_wait);
browserNotReached = true;

} else {

GenerateFailure.failThisTest(“Selenium web server

seems to have died.”);

}
//Don't reset state to found, since when it times out the

action still goes through occasionally

} catch (TimeoutException e) {

currentState = ActionState.VALIDATING;
Logger.log(“Webdriver timed out, retrying”,

LogLevel.ERROR);

if (!seleniumTimeout) {

startTime= System.currentTimeMillis( );
endTime = startTime + (max_wait);
seleniumTimeout = true;

}

} catch (StaleElementReferenceException e) {

currentState = ActionState.VALIDATING;

Logger.log(“Stale element reference”,
LogLevel.ERROR);

} catch (UnhandledAlertException e){

currentState = ActionState.VALIDATING;

Logger.log(“Unhandled alert exception”,
LogLevel.ERROR);

} catch (NoSuchWindowException e){

currentState = ActionState.VALIDATING;

Logger.log(“NoSuchWindowException“,

LogLevel.ERROR);

} catch (Exception e) {

currentState = ActionState.VALIDATING;
Logger.log(“Could not perform action on

element.”, LogLevel.ERROR);

}

}
if (passed == true) {

action.passedHook( );
PerformanceTracker.addClickWaitTime(action.toString( ),

timingDelta);

}
if (passed == false){

Logger.log(“Timed out waiting for condition.”,
LogLevel.ERROR);
action.failedHook( );

}

}

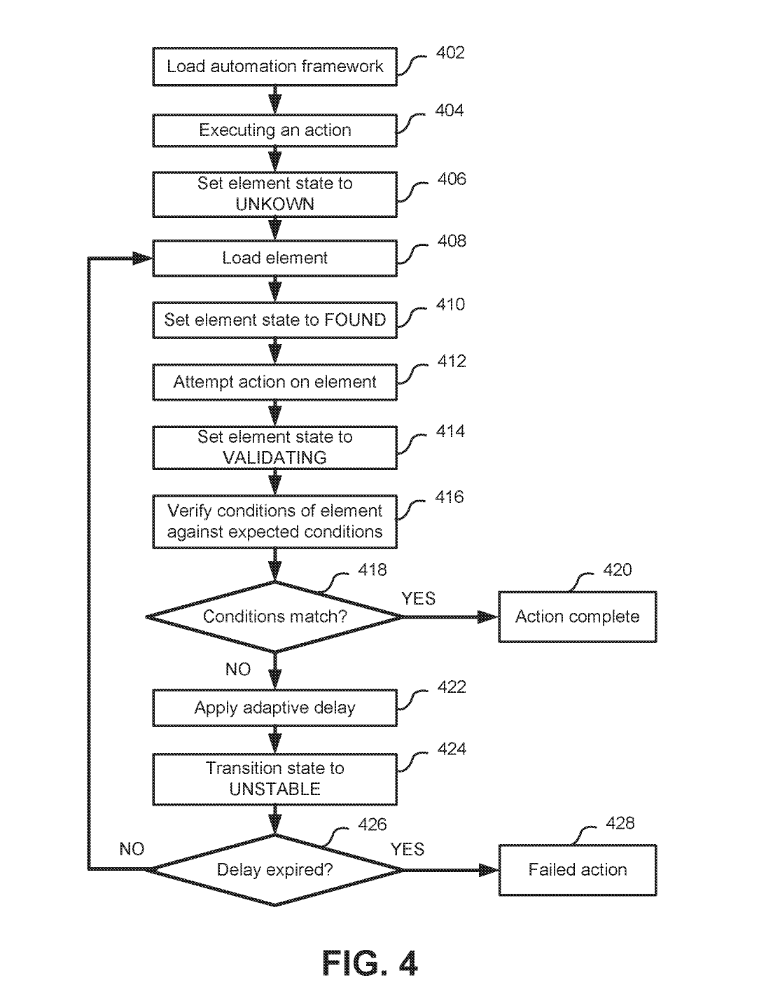

FIG. 4 depicts a method of enhanced stability of automation execution on application elements. The automation framework is loaded by the computing system (402). The framework loads test suites containing test cases to be executed against an application to verification of the applications execution. From a test step in the test suite an action is defined to be executed on an element of the application (404). A state associated with the element in the application is set to UNKOWN (406). The element is loaded in the application, either on the computing device or on a computing device coupled the device executing the automation framework (408). When the element is loaded the state is set to FOUND (410) and the action described in the test step is executed (412). After application of the action the state is set to VALIDATING (414). The conditions of the element are verified against expect conditions defined in the test step (416). If the conditions of the element match the expected conditions (YES at 418) the test step is completed. If the conditions do not match the expected conditions (NO at 418) an adaptive delay (422) can be applied and the state can be set to UNSTABLE (424). On subsequent iterations the delay can be increased up until a defined threshold. If the delay has not expired (NO at 426) the element is loaded (408) and action re-applied. If the delay has expired (YES at 426) the action is identified as failed (428).

The automation framework and elements in the embodiments of the present disclosure may be implemented as hardware, software/program, or any combination thereof. The application may be HTML, HTML5, native applications or a hybrid application. Software codes, either in its entirety or a part thereof, may be stored in a computer readable medium or memory (e.g., as a ROM, for example a non-volatile memory such as flash memory, CD ROM, DVD ROM, Blu-ray™, a semiconductor ROM, USB, or a magnetic recording medium, for example a hard disk). The program may be in the form of source code, object code, a code intermediate source and object code such as partially compiled form, or in any other form.

It would be appreciated by one of ordinary skill in the art that the system and components shown in FIGS. 1-4 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

What is claimed is:

1. A computing device for automated testing of an application, the computing device comprising:
a processing unit for executing instructions;
a memory unit for storing instructions, which when executed by the processing unit configure the computing device to provide:
an automation framework providing an application programming interface (API) for controlling interactions with one or more user interface elements of the application; and
an execution state machine for executing action on user interface elements through the automation framework, the execution state machine comprising a plurality of states associated with the user interface element defined in the application, wherein one of the states is associated to the user interface element during execution of a test step in the automation framework wherein when a failure of an action on the user interface element occurs an adaptive delay is applied before attempting to re-execute the action until the state of the user interface element is validated or the adaptive delay is exceeded.

2. The computing device of claim 1 wherein the state machine defines the plurality of states as:
an UNKNOWN state when the user interface element is being loaded;
a FOUND state when the user interface element is successfully loaded;
a VALIDATING state when the result of an attempted action is being validated; and
an UNSTABLE state when the validation of the action fails in the VALIDATING state.

3. The computing device of claim 2, wherein when transitioning from the VALIDATING state to the UNSTABLE state upon failing the attempted action the adaptive delay is applied.

4. The computing device of claim 3, wherein the adaptive delay increases the delay upon each subsequent delay.

5. The computing device of claim 2, wherein when validating the attempted action in the VALIDATING state, one or more conditions are checked against expected conditions resulting from execution of the action.

6. The computing device of claim 5, wherein the expected conditions are selected from a plurality of predefined conditions.

7. The computing device of claim 6, wherein the plurality of predefined conditions comprise one of:
AlertVisible;
ElementAttributeContains;
ElementAttributeNotContains;
ElementChanged;
ElementCheckboxValueEquals;
ElementClickable;
ElementEnabled;
Elementlnvisible;
ElementIsSelected;
ElementTextContains;
ElementTextEquals;
ElementValueEquals;
ElementVisible;
WindowClosed; and
WindowOpened.

8. The computing device of claim 1 wherein the application is a web application and the user interface element are is a web-based user interface.

9. The computing device of claim 1, wherein the state machine has a maximum timeout wherein the testing is terminated when the maximum timeout is reached.

10. A method of automated testing of an application executed on a computing device, the method comprising:
executing an action on an interface element in the application identified in a test step;
setting a state associated with an element when the interface element is being loaded;
loading the interface element in the application associated with the action;
attempting the action defined for the interface element;
changing the state associated with the interface element during execution;
verify conditions of the element against expected conditions;
applying an adaptive delay between subsequent execution of the actions when the expected conditions for the interface element are not met;
iteratively re-executing the action on the interface element where the adaptive delay is applied until the action is verified or the adaptive delay expires.

11. The method of claim 10 wherein changing the state comprises:
setting a state associated with an element defined for the action to UNKNOWN when a web element is being loaded;
setting the state associated with the element to FOUND when the web element is successfully loaded;
setting the state to VALIDATING when the result of an attempted action is being validated; and
setting the state to UNSTABLE when the validation of the action fails in the VALIDATING state.

12. The method of claim 11, wherein when transitioning from the VALIDATING state to the UNSTABLE state upon failing the attempted action the adaptive delay is applied.

13. The method of claim 12, wherein the adaptive delay increases the delay upon each subsequent delay.

14. The method of claim 11, wherein when validating the attempted action in the VALIDATING state, one or more conditions are checked against expected conditions resulting from execution of the action.

15. The method of claim 14, wherein the expected conditions are selected from a plurality of predefined conditions.

16. The method of claim 10 wherein the application is a web application and the user interface element are web-based user interface elements defined in a browser.

17. The method of claim 10, wherein the state machine has a maximum timeout wherein the testing is terminated when the maximum timeout is reached.

18. The method of claim 10 wherein the adaptive delay is increased by 1 second on each subsequent attempt until a maximum timeout is reached.

19. A non-transitory computer readable memory containing instructions for automated testing of an application executed on a computing device, the instructions which when executed by a processor performing:
executing an action on an interface element in the application identified in a test step;
setting a state associated with an element when the interface element is being loaded;
loading the interface element in the application associated with the action;
attempting the action defined for the interface element;
changing the state associated with the interface element during execution;
verify conditions of the element against expected conditions;
applying an adaptive delay between subsequent execution of the actions when the expected conditions for the interface element are not met;
iteratively re-executing the action on the interface element where the adaptive delay is applied until the action is verified or the adaptive delay expires.
